(19) United States
(12) Patent Application Publication
(10) Pub. No.: US 2017/0173532 A1
(43) Pub. Date: Jun. 22, 2017

(54) WATER TREATMENT SYSTEM AND WORKING MEDIUM THEREFOR

(71) Applicant: Kabushiki Kaisha Toshiba, Minato-ku (JP)

(72) Inventors: Tomohito IDE, Inagi (JP); Kenji SANO, Tokyo (JP); Akiko SUZUKI, Tokyo (JP); Toshihiro IMADA, Kawasaki (JP)

(73) Assignee: Kabushiki Kaisha Toshiba, Minato-ku (JP)

(21) Appl. No.: 15/266,600

(22) Filed: Sep. 15, 2016

(30) Foreign Application Priority Data
Dec. 21, 2015 (JP) 2015-248561

(51) Int. Cl. B01D 61/00; B01D 61/02; C02F 1/44

(52) U.S. Cl. CPC B01D 61/005; C02F 1/441; C02F 1/445; B01D 61/025; B01D 2313/24; C02F 2103/08

(57) ABSTRACT

According to one embodiment, a water treatment system includes a first chamber which accommodates water to be treated, a second chamber which accommodates a working medium which induces an osmotic pressure and an osmosis membrane which separates the first chamber and the second chamber from each other. The working medium is an aqueous solution which contains an acid having a hydroxy group in a side chain, or a metal salt thereof.

### CROSS-REFERENCE TO RELATED APPLICATIONS

This application is based upon and claims the benefit of priority from Japanese Patent Application No. 2015-248561, filed Dec. 21, 2015, the entire contents of which are incorporated herein by reference.

### FIELD

Embodiments described herein relate generally to a water treatment system and a working medium used for the water treatment system.

### BACKGROUND

When a solution having low concentration and another solution having high concentration are separated via an osmosis membrane (semi-permeable membrane), the solvent of the solution of low concentration permeate through the osmosis membrane to transfer to the side of the solution having high concentration. A desalination system which desalinates seawater or the like into freshwater, or an osmotic-pressure power generation system which generates power by rotating the turbine by utilizing this solvent transfer phenomenon are conventionally known. Further, a concentration system which concentrates foods or sludge by utilizing a water transfer process is also known. The solution of the high concentration side is the working medium (draw solution), and there have been various types of working media proposed.

The solute generally used for a draw solution is sodium chloride. In an example (presented by T. S. Chung et al.), an organic salt is also used as the solute of a draw solution, but organic salts are inferior to sodium chloride as the solute of a draw solution.

Another example (proposed by M. Hamdan et al.) is a draw solution in which two or more types of solutes are mixed. In some mixtures of two or more mineral salts, a synergistic effect is observed. However, there has been a report indicating that when a mixture of a mineral salt and saccharose exhibits an adverse effect in which the flux passing through an osmosis membrane decreases.

### BRIEF DESCRIPTION OF THE DRAWINGS

FIG. 1 is a schematic diagram showing a desalination system according to the first embodiment.

FIG. 2 is a schematic diagram showing a condensation system according to the first embodiment.

FIG. 3 is a schematic diagram showing a circulatory osmotic-pressure power generation system according to the second embodiment.

FIG. 4 is a diagram showing a syringe test device.

FIG. 5 is another diagram showing the syringe test device.

FIG. 6 is a graph indicating the results of Examples 6 to 18.

FIG. 7 is a graph showing the results of Example 19.

### DETAILED DESCRIPTION

In general, according to one embodiment, there is provided a water treatment system comprising a first chamber which accommodates a solution to be treated, a second chamber which accommodates a working medium (draw solution) which induces an osmotic pressure and an osmosis (semi-permeable) membrane which separates the first chamber and the second chamber from each other, wherein the working medium is an aqueous solution which contains an acid having a hydroxy group in a side chain, or a metal salt of the acid.

According to such a water treatment system, a solute and/or concentration difference is produced between the to-be-treated water in the first chamber and the working medium in the second chamber generates osmotic pressure, and water in the to-be-treated water in the first chamber permeates the osmosis membrane and transfers to the working medium in the second chamber.

In the first embodiment, the working medium is an aqueous solution which contains an acid having a hydroxy group in a side chain, or a metal salt thereof, and exhibits induction of a high osmotic pressure. Also, the working medium is an aqueous solution which contains a mixture of at least two or more kinds of compounds selected from the group consisting of acids having a hydroxy group in a side chain, or metal salts thereof, and specific polyhydric alcohols, and exhibits induction of a high osmotic pressure. With these structures, as the water in the to-be-treated water in the first chamber permeates the osmosis membrane and transfers to the working medium in the second chamber, a high permeation flux can be produced.

Thus, a water treatment system can be efficiently treated, for example, desalinate or concentrate water to be treated, and also can be provided driving at low cost.

Examples of the to-be-treated water are saline water (sea water), lake water, river water, pond water, domestic wastewater, industrial wastewater and mixtures thereof. When the to-be-treated water is saline water, the salt concentration of the saline water is preferably 0.05 to 4%.

The osmosis (semi-permeable) membrane may be, for example, a forward osmosis (FO) membrane or a reverse osmosis (RO) membrane. Note that an FO membrane is preferable.

The osmosis membrane may be, for example, a cellulose acetate film, polyamide film or the like. The osmosis membrane has preferably a thickness of 45 to 250 μm.

The working medium (draw solution) which induces an osmotic pressure is an aqueous solution which contains an acid having a hydroxy group in a side chain, or a metal salt thereof. The working medium is preferably, in particular, an aqueous solution which contains a carboxylic acid having a hydroxy group in its side chain, or an equivalent thereof.

The concentration of the solute in the working medium, that is, an acid having a hydroxy group in its side chain or a metal salt thereof is preferably adjusted based on the concentration of the solute in the to-be-treated water to be employed, the type and characteristics of the acid having a hydroxy group in a side chain, or the metal salt thereof. Usually, it is preferable that the solute concentration in the working medium is 10 to 70% by weight, more preferably, 30 to 70% by weight, and most preferably, 50 to 70% by weight. However, if some inconveniency occurs, such as the viscosity arises, it is preferably adjusted to lower the concentration. The upper limit of the concentration is dependent on the solubility unique to the material.

The carboxylic acid having a hydroxy group in a side chain has preferably such a structure of hydroxycarboxylic acid represented by Formula 1 below:

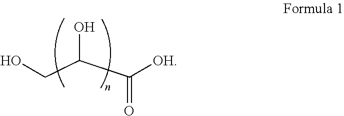

Where n is an integer of 0 to 6.

Examples of hydroxycarboxylic acid represented by Formula 1 include gluconic acid, lactic acid, glycolic acid and glyceric acid. Especially, gluconic acid is preferable.

The carboxylic acid having a hydroxy group in a side chain has preferably a structure of uronic acid derived from a monosaccharide represented by Formula 2 below:

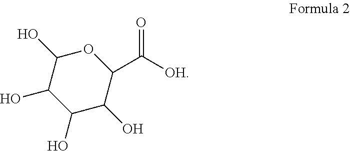 [SMILES: O=C(O)C1OC(O)C(O)C(O)C1O]

The uronic acid derived from a monosaccharide may change to a hydrolyzed structure (glucuronic acid) represented by Formula 3 below, or a lactonized structure represented by Formula 4 below, to be contained in the working medium:

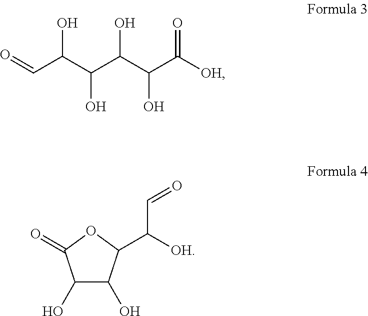 [SMILES: O=CC(O)C(O)C(O)C(O)C(=O)O ; O=CC(O)C1OC(=O)C(O)C1O]

The equivalent of the carboxylic acid having a hydroxy group in a side chain has preferably a structure represented by Formula 5 below:

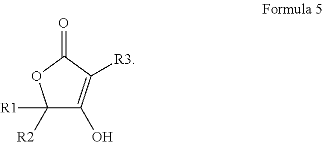

Where R1, R2 and R3 each represent a substituent selected from hydrogen, OH group and a polyol chain and may be the same or different from each other.

In terms of cost and the like, the equivalent of the carboxylic acid represented by Formula 5 is preferably a glucoside ascorbate whose R1 is a 1,2-dihydroxyethyl group, R2 is hydrogen and R3 is glucoside, a 3—O-ethylascorbic acid whose R1 is a 1,2-dihydroxyethyl group, R2 and R3 each are hydrogen and HO group is ethylated or an ascorbyl phosphate whose R1 is a 1,2-dihydroxyethyl group, R2 is hydrogen and R3 is HO group and HO group in Formula 5 is condensed with phosphate acid.

The working medium includes preferably a hydroxycarboxylic acid represented by Formula 1 above, uronic acid derived from a monosaccharide represented by Formula 2 above, an alkali metal salt of a carboxylic acid having a hydroxy group in a side chain, which is selected from the group consisting of a hydrolyzed structure represented by Formula 3, which has been changed from the uronic acid represented by Formula 2 above, and a lactonized structure represented by Formula 4, which has been changed from the uronic acid represented by Formula 2, or an alkali metal salt of an equivalent of the carboxylic acid represented by Formula 5 above. Examples of the alkali metal are sodium and potassium.

Examples of the alkali metal salt of the carboxylic acid having a hydroxy group in a side chain include sodium gluconate, potassium gluconate, sodium glucuronate, potassium glucuronate, sodium lactate, potassium lactate, sodium glycolate, potassium glycolate, sodium glycerate, potassium glycerate, sodium uronate, potassium uronate, a hydrolyzed or lactonized structure changed from sodium uronate and a hydrolyzed or lactonized structure changed from potassium urinate.

Examples of the alkali metal salt of the equivalent of the carboxylic acid include sodium ascorbyl phosphate, potassium ascorbyl phosphate.

In the first embodiment, the working medium may be an aqueous solution which contains a mixture of at least two or more kinds of compounds selected from the group consisting of the acids having a hydroxy group in a side chain, or metal salts thereof, and polyhydric alcohols represented by Formula 6 below:

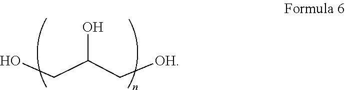

Where n is an integer of 0 to 6.

When n of Formula 6 is 0, 1 or 3, the compound is ethylene glycol, glycerol or xylitol, respectively, and when n of Formula 6 is 4, the compound is sorbitol or mannitol. When n of Formula 6 is 5, the compound is perseitol and volemitol. When n of Formula 6 is 6, the compound is, for example, D-erythro-D-galacto-octitol.

Examples of the mixture of two or more kinds of compounds are:

1) a mixture of two or more kinds of acids having a hydroxy group in a side chain;

2) a mixture of two or more kinds of metal salts of acids having a hydroxy group in a side chain;

3) a mixture of two or more kinds of polyhydric alcohols represented by Formula 6 above;

4) a mixture of two or more kinds of acids having a hydroxy group in a side chain and metal salts of acids having a hydroxy group in a side chain;

5) a mixture of two or more kinds of acids having a hydroxy group in a side chain and polyhydric alcohols represented by Formula 6 above; and 6) a mixture of two or more kinds of metal salts of acids having a hydroxy group in a side chain and polyhydric alcohols represented by Formula 6 above.

The mixture ratio between two or more kinds of compounds is arbitrary regardless of whether the compounds of 1) to 3) above are of the same system or those of 4) to 6) above are of different systems. For example, in the case of two kinds, it is preferable that the first compound occupies 45 to 55% by weight and the second compound occupies 45 to 55% by weight.

In the case of three kinds, it is preferable to carry out the compound of a second and to carry out the third compound for a first compound to 30 to 36% of the weight 30 to 36% of the weight 30 to 36% of the weight. In the case of two kinds, the preferable mixture ratio between the two or more kinds of compounds is 1:1 by weight ratio, and in the case of three kinds, it is 1:1:1 by weight ratio.

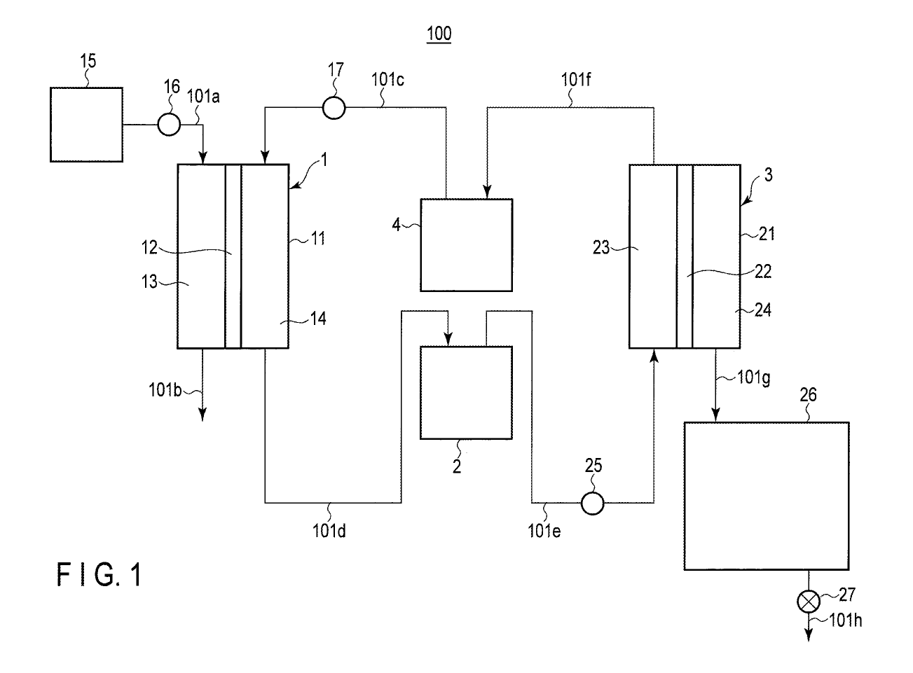

Next, a desalination system, which is an example of the water treatment system according to the first embodiment will be described with reference to the schematic view shown in FIG. 1.

A desalination system 100 comprises an osmotic pressure generator 1, a dilution working medium tank 2, a reverse osmosis membrane separator 3 and a concentration working medium tank 4. The osmotic pressure generator 1, the dilution working medium tank 2, the reverse osmosis membrane separator 3 and the concentration working medium tank 4 are connected in this order to form a loop. The working medium (draw solution) which induces an osmotic pressure circulates through this loop. That is, the working medium circulates through the osmotic pressure generator 1, the dilution working medium tank 2, the reverse osmosis membrane separator 3 and the concentration working medium tank 4 in this order.

The osmotic pressure generator 1 comprises, for example, a first treatment container 11 which is airtight. The first treatment container 11 is compartmentalized horizontally with, for example, an osmosis membrane (for example, forward osmosis (FO) membrane) 12 into a first chamber 13 on a left-hand side and a second chamber 14 on a right-hand side. A saline water tank 15 is connected through a pipeline 101a to an upper portion of the first treatment container 11 in which the first chamber 13 is located. A first pump 16 is provided in the pipeline 101a. A pipeline 101b to discharge concentrated saline water is connected to a lower portion of the first treatment container 11 in which the first chamber 13 is located.

The concentration working medium tank 4 is connected through a pipeline 101c to the upper portion of the first treatment container 11 in which the second chamber 14 is located. A second pump 17 is provided in the pipeline 101c. The lower portion of the first treatment container 11, in which the second chamber 14 is located, is connected to the dilution working medium tank 2 through a pipeline 101d.

The reverse osmosis membrane separator 3 comprises, for example, a second treatment container 21 which is airtight.

The second treatment container 21 is compartmentalized horizontally with, for example, a reverse osmosis (RO) membrane 22 into a third chamber 23 on a left-hand side and a fourth chamber 24 on a right-hand side.

The dilution working medium tank 2 is connected through a pipeline 101e to a lower portion of a second treatment container 31 in which the third chamber 23 is located. A third pump 25 is provided in the pipeline 101e. An upper portion of the second treatment container 21, in which the third chamber 23 is located, is connected to the concentration working medium tank 4 through a pipeline 101f. The lower portion of the second treatment container 21, in which the fourth chamber 24 is located, is connected to a pure-water tank 26 through a pipeline 101g. A pipeline 101h is connected to the pure-water tank 26 so as to guide out pure water in the pure-water tank 26 to the outside to be collected. An on-off valve 27 is provided in the pipeline 101h, and it is opened if the amount of the pure water in the pure-water tank 26 exceeds a predetermined quantity.

Next, the desalination operation by the desalination system shown in FIG. 1 will be described.

The first pump 16 is driven to supply saline water (for example, seawater) through the pipeline 101a into the first chamber 13 of the osmotic pressure generator 1 from the saline water tank 15. At almost the same time as the supply of the seawater, the second pump 17 is driven to supply a concentration working medium through the pipeline 101c into the second chamber 14 of the osmotic pressure generator 1 from the concentration working medium tank 4. Here, the concentration working medium supplied to the second chamber 14 has a high concentration as compared to the salt concentration of the seawater supplied to the first chamber 13. Thus, an osmotic pressure difference is produced between the seawater in the first chamber 13, and the concentration working medium in the second chamber 14, and therefore the water content in the seawater permeates the osmosis membrane 12 and transfers into the second chamber 1. Here, the concentration working medium in the second chamber 14 is an aqueous solution which contains an acid a hydroxy group in a side chain, or a metal salt thereof, or an aqueous solution containing a mixture of at least two or more kinds compounds selected from the group consisting of acids which contain a hydroxy group in a side chain, metal salts thereof, and specific polyhydric alcohols. These aqueous solution exhibit a high osmotic-pressure induction effect. For this reason, the water content in the seawater in the first chamber 13 permeates the osmosis membrane 12 and transfers to the concentration working medium in the second chamber 14. While this transfers, high permeation flux of water is produced. As a result, a large quantity of water in the seawater in the first chamber 13 can be moved to the concentration working medium of the second chamber 14, thereby executing a highly efficient desalination process to extract water (pure water) from saline water.

In the osmotic pressure generator 1, as the water content in the seawater transfers from the first chamber 13 to the concentration working medium in the second chamber 14, the sea water is discharged from the first chamber 13 through the pipeline 101b as concentrated seawater. On the other hand, the concentration working medium is diluted with the water that is transferred.

The dilution working medium in the second chamber 14 is sent out through the pipeline 101d and reserved in the dilution working medium tank 2. When the dilution working medium is reserved to a predetermined liquid level in the dilution working medium tank 2, the third pump 25 is driven. As the third pump 25 is driven, the dilution working medium in the tank 2 is supplied to the third chamber 23 of the second treatment container 21 of the reverse osmosis membrane separator 3 by a desired pressure through the pipeline 101e. The water in the dilution working medium supplied to the third chamber 23 by the desired pressure is forced to permeate the reverse osmosis (RO) membrane 22 and moved to the fourth chamber 24. The dilution working medium in the third chamber 23 is concentrated when the water content permeates and transfers to the fourth chamber 24. The concentration working medium obtained is sent out to the concentration working medium tank 4 from the third chamber 23. The concentration working medium in the concentration working medium tank 4 is supplied into the second chamber 14 of the osmotic pressure generator 1 by driving the second pump 17, and is used for the desalination process to extract water (pure water) from saline water as described above.

On the other hand, the water (pure water) which transferred into the fourth chamber 24 is sent out to the pure-water tank 26 through the pipeline 101g. When the amount of water in the pure-water tank 26 exceeds a predetermined level, the on-off valve 27 is opened to send out water (pure water) to the outside through the pipeline 101h, to be collected.

As described above, it is possible to provide a desalination system which can efficiently desalinate seawater (recovery of pure water) and is operable at low cost.

Note that in the desalination system shown in FIG. 1, the osmotic pressure generator includes the first treatment container compartmentalized horizontally by an osmosis membrane into the first and second chambers, but the first treatment container may be compartmentalized vertically by an osmosis membrane into the first and second chambers.

In the desalination system shown in FIG. 1, the dilution working medium may be concentrated not only by a reverse osmosis membrane separator comprising a reverse osmosis (RO) membrane, but also by any equipment which removes water from the dilution working medium.

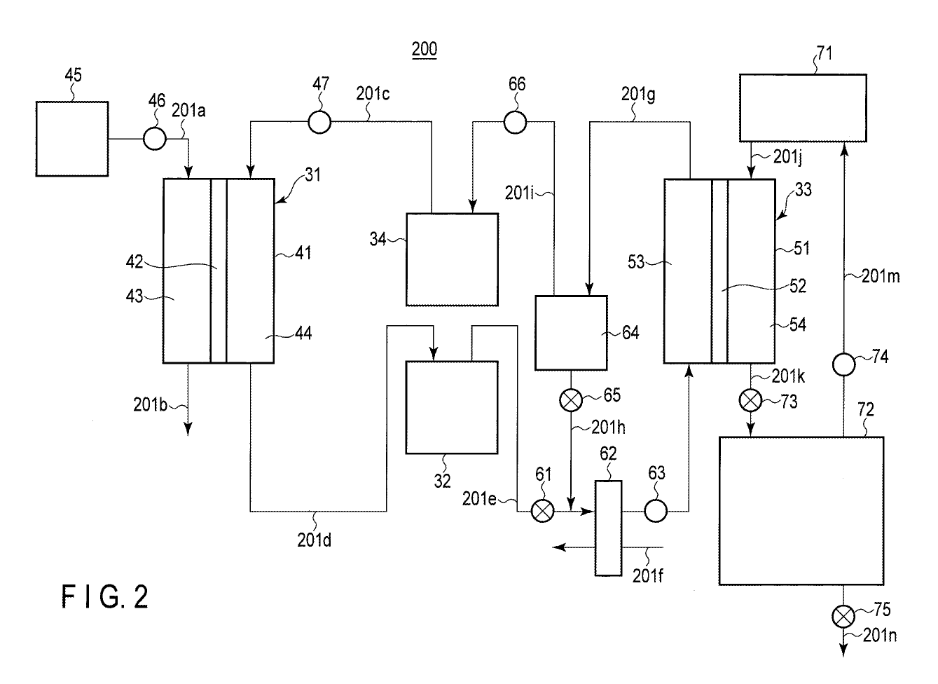

Next, the concentration system, which is one example of the water treatment system according to the first embodiment, will be described with reference to the diagram showing in FIG. 2.

A concentration system 200 comprises an osmotic pressure generator 31, a dilution working medium tank 32, a membrane distillation separator 33 and a concentration working medium tank 34. The osmotic pressure generator 31, the dilution working medium tank 32, the membrane distillation separator 33 and the concentration working medium tank 34 are connected in this order to form a loop. The working medium (draw solution) circulates through the loop. That is, the working medium circulates through the osmotic pressure generator 31, the dilution working medium tank 32, the membrane distillation separator 33 and the concentration working medium tank 34 in this order.

The osmotic pressure generator 31 comprises, for example, a first treatment container 41 which is airtight. The first treatment container 41 is compartmentalized, for example, horizontally by an osmosis membrane 42 (for example, forward osmosis (FO) membrane) into a first chamber 43 on a left-hand side and a second chamber 44 on a right-hand side. A raw-material liquid tank 45 which accommodates water to be treated, that is, a raw material liquid such as industrial wastewater, is connected through a pipeline 201a to an upper portion of the first treatment container 41 in which the first chamber 43 is located. The first pump 46 is provided in the pipeline 201a. A pipeline 201b is connected to the lower portion of the first treatment container 41, in which the first chamber 43 is located, so as to discharge the concentrated raw-material liquid in the first chamber 43 to the outside to collect the concentrated raw-material liquid.

The concentration working medium tank 34 is connected through a pipeline 201c to the upper portion of the first treatment container 41 in which the second chamber 44 is located. A second pump 47 is prepared in the pipeline 201c. A lower portion of the first treatment container 11, in which the second chamber 44 is located, is connected to the dilution working medium tank 32 through a pipeline 201d. The membrane distillation separator 33 comprises, for example, a second treatment container 51 which is airtight.

The second treatment container 51 is compartmentalized, for example, horizontally with a dehydration film 52 consisting, for example of porous latex film into a third chamber 53 on a left-hand side and a fourth chamber 54 on a right-hand side.

The dilution working medium tank 32 is connected through a pipeline 201e to the lower portion of the second treatment container 51 in which the third chamber 53 is located. A first on-off valve 61, a heat exchanger 62 and a third pump 63 are provided in the pipeline 201e in this order along the direction of flow of the working medium. For example, a pipeline 201f of exhaust heat gas is provided to intersect the heat exchanger 62, and thus the working medium flowing through the pipeline 201e exchanges heat with the exhaust heat gas to heat the working medium. The upper portion of the second treatment container 51, in which the third chamber 53 is located, is connected to the upper portion of the circulation tank 64 through a pipeline 201g. The circulation tank 64 is connected to a portion of the pipeline 201e located between the first on-off valve 61 and the heat exchanger 62 through a pipeline 201h. A second on-off valve 65 is provided in the pipeline 201h.

With the above-described structure, the third chamber 53 of the membrane distillation separator 33, the circulation tanks 64 and the pipelines 201e, 201g and 201h which connect these components, form a loop. More specifically, the dilution working medium dehydrated by the third chamber 53, which will be described later, and reserved in the circulation tank 64 opens the second on-off valve 65 and drives the third pump 63, to circulate through the pipeline 201h, the pipeline 201e, the third chamber 53 and the pipeline 201g, thus forming a dilution working medium circulatory system. Note that the dilution working medium circulatory system can be isolated from the dilution working medium tank 32 by closing the first on-off valve 61 in the circulation of the dilution working medium.

The circulation tank 64 is connected to the concentration working medium tank 34 through a pipeline 201i. A fourth pump 66 is provided in the pipeline 201i.

A first pure-water tank 71 is connected through a pipeline 201i to an upper portion of the second treatment container 51 in which the fourth chamber 54 is located. A lower portion of the second treatment container 51, in which the fourth chamber 54 is located, is connected to a second pure-water tank 72 through a pipeline 201k. A third on-off valve 73 is provided in the pipeline 201k, and is closed when pure water is not being circulated to retain pure water in the fourth chamber 54. The second pure-water tank 72 is connected to the first pure-water tank 71 through a pipeline 201m. A fifth pump 74 is provided in the pipeline 201m. With the above-described structure, the first pure-water tank 71, the fourth chamber 54 of the membrane distillation separator 33, the second pure water tank 72 and the pipelines 201j, 201k and 201m which connect these components form a loop. More specifically, the pure water in the second pure-water tank 72 opens the third on-off valve 73 and drives the fifth pump 74 to circulate through the pipeline 201m, the first pure-water tank 71, the pipeline 201j , the fourth chamber 54 and the pipeline 201k, thus forming a pure-water circulation cooling system.

A pipeline 201n is connected to the second pure-water tank 72 so as to sending out the pure water in the second pure-water tank 72 to the outside to be collected. A fourth on-off valve 75 is provided in the pipeline 201n. The fourth on-off valve 75 is closed while circulating pure water as described above and when the amount of pure water in the second pure-water tank 75 exceeds a predetermined level, the valve is opened.

Next, the concentration by the concentration system shown in FIG. 2 will be described.

The first pump 46 is driven to supply the raw-material liquid (for example, industrial wastewater) which is water to be treated through the pipeline 201a into the first chamber 43 of the osmotic pressure generator 31 from the raw-material liquid tank 45.

At almost the same time as the supply of the raw-material liquid, the second pump 47 is driven to supply a concentration working medium through the pipeline 201c into the second chamber 44 of the osmotic pressure generator 31 from the concentration working medium tank 34. Here, the concentration working medium supplied to the second chamber 44 has a high concentration as compared to the concentration of the raw-material liquid supplied to the first chamber 43. Thus, an osmotic pressure difference is produced between the raw-material liquid in the first chamber 43, and the concentration working medium in the second chamber 44, and therefore the water content in the raw-material liquid permeates the osmosis membrane 42 and transfers into the second chamber 44. Here, the concentration working medium in the second chamber 44 is an aqueous solution which contains an acid having a hydroxy group in a side chain, or a metal salt thereof, or an aqueous solution containing a mixture of at least two or more kinds compounds selected from the group consisting of acids having a hydroxy group in a side chain, or metal salts thereof, and specific polyhydric alcohols. These aqueous solution exhibit a high osmotic-pressure induction effect. For this reason, the water content in the raw-material liquid in the first chamber 43 permeates the osmosis membrane 32 and transfers to the concentration working medium in the second chamber 44. While this transfers, high permeation flux of water is produced. As a result, a large quantity of water in the raw-material liquid in the first chamber 43 can be moved to the concentration working medium of the second chamber 44, thereby making it possible to execute a highly efficient raw-material-liquid concentration process.

In the osmotic pressure generator 31, as the water content in the raw-material liquid transfers from the first chamber 43 to the concentration working medium in the second chamber 44, the raw-material liquid is discharged from the first chamber 43 through the pipeline 201b as concentrated raw-material liquid to be collected. On the other hand, the concentration working medium is diluted with the water that is transferred.

The dilution working medium of the second chamber 44 is sent out through the pipeline 201d and retained in the dilution working medium tank 32. When the dilution working medium is reserved up to a predetermined amount in the dilution working medium tank 32, the first on-off valve 61 provided in the pipeline 201e is opened, the second on-off valve 65 provided in the pipeline 201h is closed, and the third pump 63 is driven. As the third pump 63 is driven, the dilution working medium in the dilution working medium tank 32 is supplied to the third chamber 53 of the second treatment container 51 of the membrane distillation separator 33 through the pipeline 201e. While the dilution working medium being supplied to the third chamber 53, the dilution working medium which circulates the pipeline 201e exchange heat with the exhaust heat gas flowing through the pipeline 201f in the heat exchange mechanism 62 which intersects the pipeline 201f, to be heated. Further, the pure water in the second pure-water tank 72 is circulated to the pipeline 201m, the first pure-water tank 71, the pipeline 201j, the fourth chamber 54 and the pipeline 201k by opening the third on-off valve 73 and driving the fifth pump 74, to cool, with the pure water, the dehydration film 52 of the membrane distillation separator 33, which consists, for example, of the porous latex film, from the fourth chamber 54 side. That is, the fourth chamber 54 side of the dehydration film 52 is cooled by the pure-water circulation cooling system.

As described above, the dehydration film 52 of the membrane distillation separator 33 is cooled with the pure water circulating in the fourth chamber 54, while supplying the dilution working medium thus heated through the pipeline 201e to the third chamber 53 of the membrane distillation separator 33. Therefore, the water content in the dilution working medium evaporates within the third chamber 53, and the vapor permeates the dehydration film 52 consisting, for example, of the porous latex film and transfers to the fourth chamber 54. Then, it is cooled down with the circulating pure water through to be concentrated and taken in. In other words, the dilution working medium is dehydrated in the third chamber 53. Then, the dehydrated dilution working medium in the third chamber 53 is sent out through pipeline 201g to the circulation tank 64 to be reserved therein. The dilution working medium reserved in the circulation tank 64 is concentrated by the dehydration process described above to a certain concentration.

However, such a level of concentration is too low to be suitably used as the concentration working medium described above. Therefore, when a predetermined amount of the dehydrated dilution working medium is reserved in the circulation tank 64, the on-off second valve 65 is opened to allow the dehydrated dilution working medium in the tank 64 flow into the pipeline 201h. Simultaneously, the first on-off valve 61 is closed to isolate the dilution working medium circulatory system comprising the circulation tank 64, the pipeline 201h, the pipeline 201e, the third chamber 53 and the pipeline 201g, from the dilution working medium tank 32.

In the dilution working medium circulatory system and pure-water circulation cooling system, the dehydration process is repeated a plurality of times, which includes the evaporation of water of the dilution working medium in the third chamber 53, the permeation of vapor through the dehydration film 52, the transfer to the fourth chamber 54, and the cooling by the circulating pure water on the fourth chamber 54 side for concentration. By this operation, the dilution working medium is process to have such a concentration that it can be employed as a concentration working medium. After the circulation of the dilution working medium and the dehydration, the on-off second valve 65 is closed to reserve the concentration working medium in the circulation tank 64. The water (pure water) which transferred to the fourth chamber 54 is sent out together with the pure water circulating to the second pure-water tank 72 through the pipeline 201k.

After reserving in the circulation tank 64 the concentration working medium having such a concentration that it can be employed as a concentration working medium, the driving of the fifth pump 74 is stopped to suspend circulation of the pure water to the fourth chamber 54, and then the third on-off valve 73 is closed. Note that if the amount of pure water in the second pure-water tank 72 exceeds a predetermined level, the fourth on-off valve 75 is opened to send the exceeding pure water to the outside through the pipeline 201n to be collected. The concentration working medium in the circulation tank 64 is sent out to the concentration working medium tank 34 through the pipeline 201i by driving the fourth pump 64. The concentration working medium in the concentration working medium tank 34 is supplied into the second chamber 44 of the osmotic pressure generator 31 by driving the second pump 47, to be utilized for the concentration of the raw-material liquid as described above.

Therefore, in the osmotic pressure generator 31, the raw-material liquid is supplied to the first chamber 43 and the concentration working medium is supplied to the second chamber 44. Thus, the water content in the raw-material liquid is moved to the concentration working medium in the second chamber 44 from the first chamber 43, and thus the raw-material liquid is concentrated and discharged through the pipeline 201b from the first chamber 43 to be collected. The concentration working medium is diluted with the water which is transferred and the dilution working medium is sent out to the dilution working medium tank 32 to be reserved.

During the concentration of the raw-material liquid by the osmotic pressure generator 31, the dilution working medium reserved in the dilution working medium tank 32 is concentrated by the dilution working medium circulatory system including the third chamber 53 of the membrane distillation separator 33 and the pure-water circulation cooling system including the fourth chamber 54 of the membrane distillation separator 33, and then sent out to the concentration working medium tank 34. Meanwhile, the water (pure water) which is transferred to the fourth chamber 54 is sent out from the second pure-water tank 72 to be collected. In this manner, the concentration of the raw-material liquid by the osmotic pressure generator 31 and the concentration of the dilution working medium by the membrane distillation separator 33 can be performed continuously.

Therefore, a concentration system which can perform the concentration of a raw-material liquid (water to be treated) such as industrial wastewater and the recovery of water efficiently at low cost can be provided.

Note that in the concentration system shown in FIG. 2, the osmotic pressure generator includes the first treatment container compartmentalized horizontally by an osmosis membrane into the first and second chambers, but the first treatment container may be compartmentalized vertically by an osmosis membrane into the first and second chambers.

In the concentration system shown in FIG. 2, the to-be-treated water (for example, a raw-material liquid) concentrated in the first chamber 43 of the osmotic pressure generator 31 is sent to the outside to be collected, but the embodiment is not limited to this. For example, for preparing a raw-material liquid having even a higher concentration, the pipeline 201b may be connected to the raw-material liquid tank 45 to form a loop of the raw-material liquid tank 45, the pipeline 201a, the first chamber 43 of the osmotic pressure generator 31 and the pipeline 201b. In this case, it is desirable to determine the concentration degree of the raw-material liquid in consideration of the osmotic pressure difference between the raw-material liquid and the concentration working medium in the osmotic pressure generator 31.

In the concentration system shown in FIG. 2, the dehydration film of the membrane distillation separator may not be the porous latex film, but as long as it has a function which passes vapor, any type of film may be employed. For example, the dehydration film may be made from Gore-Tex (brand name of W. L. Gore & Associates) or the like.

In the concentration system shown in FIG. 2, the concentration of the dilution working medium may not be performed in the membrane distillation separator comprising a dehydration film, but it may be performed by any type of device as long as it can remove the water content from the dilution working medium.

### Second embodiment

A water treatment system according to the second embodiment comprises a first chamber which accommodates water, a second chamber which accommodates a working medium (draw solution) which induces an osmotic pressure, an osmosis (semi-permeable) membrane which separates the first chamber and the second chamber from each other, a pressure exchanger connected to the second chamber and a rotator connected to the pressure exchanger. According to this water treatment system, an osmotic pressure difference is produced between the water in the first chamber and the working medium in the second chamber, and the water in the first chamber permeates the osmosis membrane and transfers to the working medium in the second chamber. As the water transfers to the working medium, a water stream is produced, which rotates the rotator to generate power.

In the second embodiment, the working medium is an aqueous which contains an acid having a hydroxy group in a side chain, or a metal salt thereof, or an aqueous solution which contains a mixture of at least two or more kinds of compounds selected from the group consisting of acids having a hydroxy group in a side chain, or metal salts thereof, and specific polyhydric alcohols, and exhibits induction of a high osmotic pressure. With this structure, as the water in the first chamber permeates the osmosis membrane and transfers to the working medium in the second chamber, a high permeation flux can be produced. As a result, the working medium to which the water transfers creates a stream having a high pressure, which can rotate the rotator at even higher speed to generate power.

Thus, a water treatment system which can efficiently rotate a rotator to generate power, and also be driven at low cost can be provided.

The osmosis (semi-permeable) membrane may be, for example, a forward osmosis (FO) membrane or a reverse osmosis (RO) membrane. Note that an FO membrane is preferable.

The osmosis membrane may be, for example, a cellulose acetate film, polyamide film or the like. The osmosis membrane has preferably a thickness of 45 to 250 μm.

The working medium which induces an osmotic pressure may be similar to those described in the first embodiment described above.

The rotator may be, for example, a turbine or a water wheel.

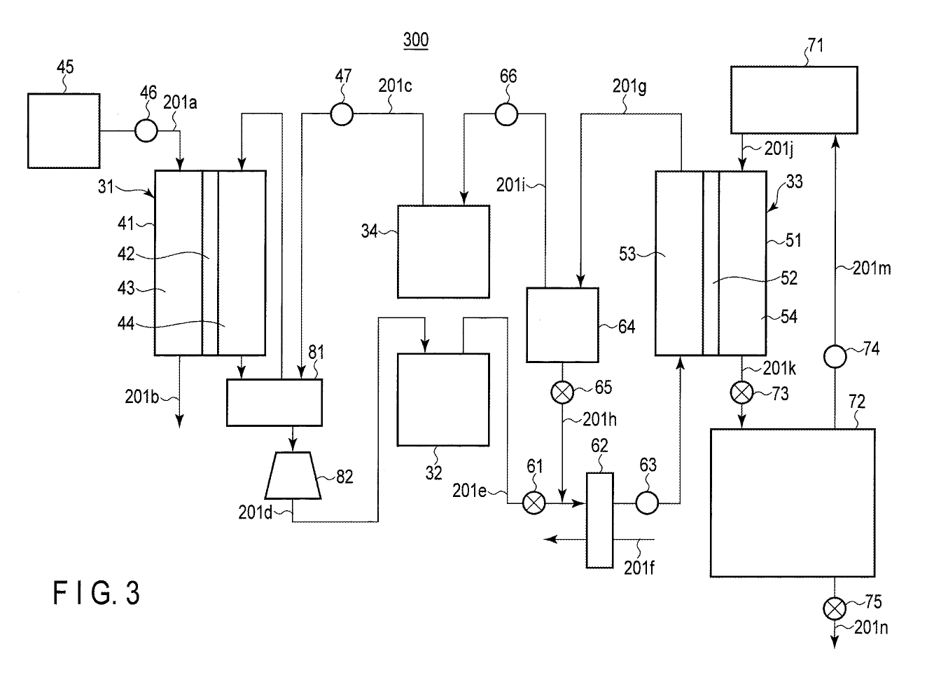

Next, a circulatory osmotic pressure power generation system, which is one example of the water treatment system according to the second embodiment, will be described with reference to the schematic diagram shown in FIG. 3. Note that structural elements similar to those shown in FIG. 2 will be designated by the same reference symbols in FIG. 3 and their explanations will be omitted.

A circulatory osmotic pressure power generation system 300 comprises, in a pipeline 201b connected to a lower portion (working medium outlet side) of a first treatment container 41 in which a second chamber 44 of an osmotic pressure generator 31 is located, a pressure exchanger 81 and a turbine 82 provided in this order along the direction of flow of a working medium. Further, a pipeline 201c connects an upper portion of the first treatment container 41 in which the second chamber 44 is located, to a concentration working medium tank 34. A portion of the pipeline 201c, which is on the downstream side with respect to the second pump 47 along the direction of flow of the working medium, is connected through the pressure exchanger 81 to the upper portion of the first treatment container 41 in which the second chamber 44 is located. To explain, the dilution working medium which has a flux generated when water permeated the osmosis membrane 42 from the first chamber 43 and transferred to the second chamber 44 in the osmotic pressure generator 31 is allowed to flow out through the pipeline 201b in which the pressure exchanger 81 is provided, from the lower portion of the first treatment container 41 in which the second chamber 44 is located. Meanwhile, the pipeline 201c in which the concentration working medium flowing out of the concentration working medium tank 34 passes, is provided to go through the pressure exchanger 81. With this structure, the concentration working medium exchanges its pressure with the dilution working medium flowing out of the second chamber 44 in the pressure exchanger 81 to lower the pressure of the dilution working medium, and raise the pressure of the concentration working medium.

Note that in the circulatory osmotic pressure power generation system 300, water is accommodated in the raw-material liquid tank 45.

Next, the power generation operation by the circulatory osmotic pressure power generation system shown in FIG. 3 will be described.

The first pump 46 is driven to supply water through the pipeline 201a into the first chamber 43 of the osmotic pressure generator 31 from the raw-material liquid tank 45. At almost the same time as the supply of the water, the second pump 47 is driven to supply the concentration working medium through the pipeline 201c into the second chamber 44 of the osmotic pressure generator 31 from the concentration working medium tank 34. Here, the concentration working medium flows through the pressure exchanger 81 provided in the pipeline 201c. The concentration working medium supplied to the second chamber 44 has a concentration sufficiently higher as compared to that of the water, which is the only solvent supplied to the first chamber 43. With this structure, an osmotic pressure difference is produced between the water in the first chamber 43 and the concentration working medium in the second chamber 44, and the water permeates the osmosis membrane 42 and transfers to the second chamber 44. Here, the working medium in the second chamber 44 is an aqueous solution which contains an acid having a hydroxy group in a side chain, or a metal salt thereof, or an aqueous solution containing a mixture of at least two or more kinds of compounds selected from the group consisting of acids having a hydroxy group in a side chain, or metal salts thereof, and specific polyhydric alcohols. Each of the working mediums exhibits induction of a high osmotic pressure. With this structure, as the water in the first chamber 43 permeates the osmosis membrane 32 and transfers to the working medium in the second chamber 44, a high permeation flux can be produced. As a result, the water in the first chamber 43 can be moved in great amount to the concentration working medium of the second chamber 44, thereby making it possible to produce a water-diluted working medium having a high pressure. Note that the water in the first chamber 43 is discharged through the pipeline 201b.

The high-pressure dilution working medium in the second chamber 44 is sent out through the pipeline 201d to the dilution working medium tank 32 and reserved therein. The pressure exchanger 81 and the turbine 82 are provided in the pipeline 201d in this order along the direction of flow of the working medium. With this structure, the pressure is exchanged between the concentration working medium which flows through the pipeline 201c from the concentration working medium tank 34 and the high-pressure dilution working medium which flows through the pipeline 201d from the second chamber 44 (passing though the turbine 82) in the pressure exchanger 81 to lower the pressure of the dilution working medium and raise the pressure of the concentration working medium as described above. The dilution working medium now having a proper pressure as a result of such pressure exchange flows into the turbine 82 and rotates it efficiently to generate power. Meanwhile, the concentration working medium now having a proper pressure as a result of the pressure exchanger is supplied to the second chamber 44 as described above.

The dilution working medium reserved in the dilution working medium tank 32 is concentrated by the dilution working medium circulatory system which includes the third chamber 53 of the membrane distillation separator 33 and the pure-water circulatory cooling system which includes the fourth chamber 54 of the membrane distillation separator 33 as in the case of the concentration system shown in FIG. 2 described above. That is, the dehydration process is repeated a plurality of times, which includes the evaporation of water of the dilution working medium in the third chamber 53, the permeation of vapor through the dehydration film 52, the transfer to the fourth chamber 54, and the cooling by the circulating pure water on the fourth chamber 54 side for concentration. By this operation, the dilution working medium is processed to have such a concentration that it can be employed as a working medium (concentration working medium), and reserved in the circulation tank 64. Then, the concentration working medium is returned to the concentration working medium tank 34. The concentration working medium in the concentration working medium tank 34 is supplied into the second chamber 44 of the osmotic pressure generator 31 by driving the second pump 47 in order to rotate the turbine 82 for power generation as described above.

As described above, the rotation of the turbine 82 by the osmotic pressure generator 31 for power generation, and the concentration of the dilution working medium by the membrane distillation separator 33 can be performed continuously. Thus, a circulatory osmotic-pressure power generation system, which can rotate the turbine efficiently to generate power, can be operated at low cost.

Note that in the circulatory osmotic-pressure power generation system shown in FIG. 3, the osmotic pressure generator includes the first treatment container compartmentalized horizontally by an osmosis membrane into the first and second chambers, but the first treatment container may be compartmentalized vertically by an osmosis membrane into the first and second chambers.

In the circulatory osmotic-pressure power generation system shown in FIG. 3, the water in the first chamber 43 of the osmotic pressure generator 31 is sent to the outside through the pipeline 201b, but the embodiment is not limited to this. For example, the pipeline 201b may be connected to the raw-material liquid tank 45 to form a loop of the raw-material liquid tank 45, the pipeline 201a, the first chamber 43 of the osmotic pressure generator 31 and the pipeline 201b.

In the circulatory osmotic-pressure power generation system shown in FIG. 3, the dehydration film of the membrane distillation separator may not be the porous latex film, but as long as it has a function which passes vapor, any type of film may be employed. For example, the dehydration film may be made from Gore-Tex (brand name of W. L. Gore & Associates) or the like.

In the circulatory osmotic-pressure power generation system shown in FIG. 3, the concentration of the dilution working medium may not be carried out by a membrane distillation separator comprising a dehydration film, but as long as it removes the water from the dilution working medium, any type of device may be used for the concentration.

Hereafter, examples will now be described with reference to drawings.

(1) Syringe Test Device

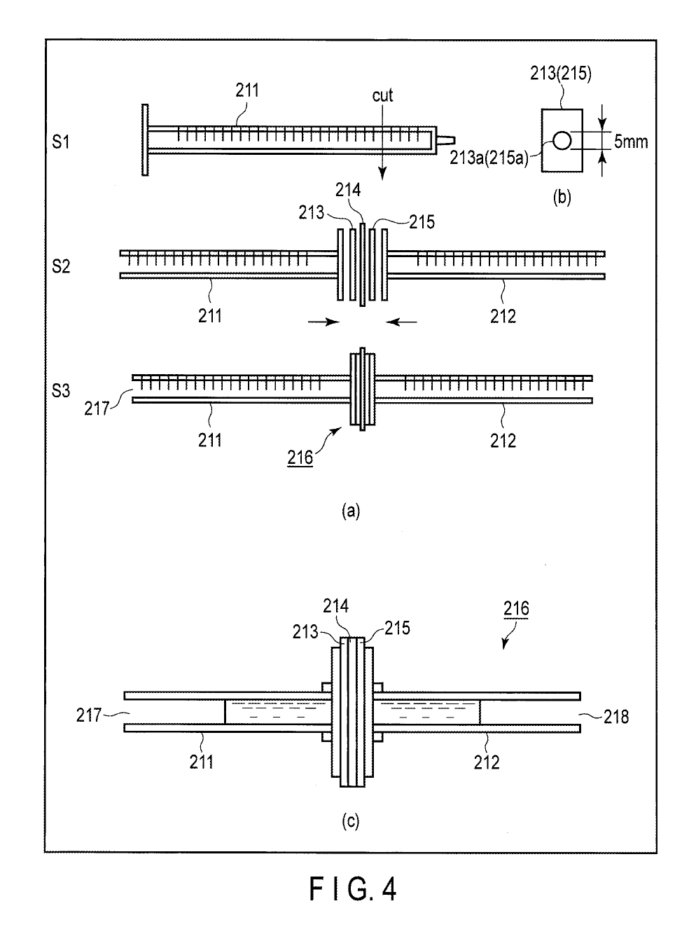

Manufacture of a syringe testing device will be described with reference to (a) of FIG. 4.

First, 1-mL plastic disposable syringes 211 and 212 including fingerplate portions 211a and 212a, respectively, on one end were prepared. Distal ends of the syringes 211 and 212, to which injection needles were to set, were cut off (S1). The fingerplate portions 211a and 212a of the two syringes 211 and 212 thus obtained by cutting were placed to face each other, and two rubber sheets 213 and 215 and one set of osmosis membrane 214 were interposed therebetween so that air might not enter (S2). The interposition was carried out in the order of the first syringe 211, the first rubber sheet 213, the osmosis membrane 214, the second rubber sheet 215 and the second syringe 212. After that, the resultant was fixed with two clips (not shown) (S3). Thus, a syringe testing device 216 was obtained.

The osmosis membrane 214 used here was an RO membrane ES20 of Nitto Denko Corporation. The first and second rubber sheets 213 and 215 were tabular rubber sheets. As shown in (b) of FIG. 4, each rubber sheet (213 and 215) had an circular hole (213a and 215a) having a diameter of 5 mm.

(2) Syringe Test

### EXAMPLE 1

A syringe testing device 216 was manufactured according to the procedure described in (1) above. Seawater (saline water having a concentration of 3.5% by weight) was accommodated in the first syringe 211 as a working medium (draw solution), and freshwater was accommodated in the second syringe 212 (see in (c) of FIG. 4). The liquids used for the test were put into the syringes 211 and 212, respectively between the processes of S1 and S2 shown in (a) of FIG. 4.

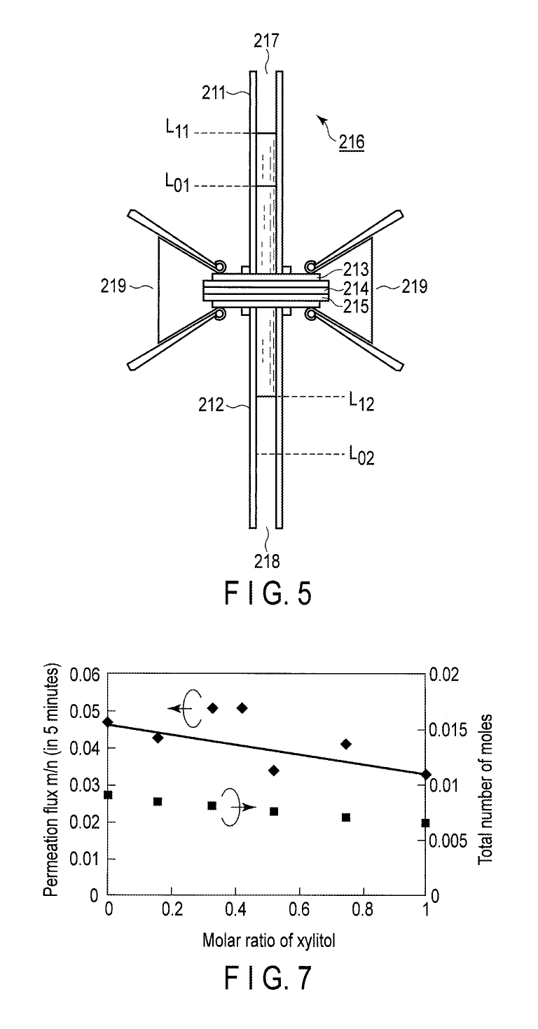

Next, as shown in FIG. 5, the first syringe 211, the first rubber sheet 213, the osmosis membrane 214, the second rubber sheet 215 and the second syringe 212 are fixed together with two clips 219, and then the resultant was set still vertically with the first syringe 211 being located above and the second syringe 212 being located below under the conditions of 25° C. and 1 atmosphere. After that, the calibration was made by reading the scale at each point of after 5 minutes, 10 minutes, 20 minutes, 30 minutes, 1 hour, 2 hours, 3 hours, 4 hours and 5 hours to measure the amount of water transferred from the second syringe 212 side to the first syringe 211 side. Note that the liquids accommodated in the syringe testing device 216 did not leak outside during the manufacturing step of the syringe testing device 216 or the test.

The amount of the freshwater introduced into the second syringe 212 downside decreasing in 5 minutes as the freshwater transferred to the first syringe 211 upside was observed, and the permeation flux was calculated from the results of the observation.

Note that in FIG. 5, L₀₁ indicates the first surface of the first syringe 211 and L₁₁ indicates the surface of the first syringe 211 after the test. Further, in FIG. 5, L₀₂ indicates the first surface of the second syringe 212 and L₁₂ indicates the surface of the second syringe 212 after the test.

### EXAMPLE 2 to 5

The permeation flux was obtained in these examples by a method similar to that of Example 1 except that a saturated aqueous solution of sodium gluconate, a saturated aqueous solution of sodium glucuronate, a saturated aqueous solution of sodium ascorbate and an aqueous solution of imidazolium acetate having a concentration of 70% by weight, were employed as the working mediums, respectively.

The results of Examples 1 to 5 will be provided Table 1 below.

TABLE 1

| | | | Permeation |
|---|---|---|---|
| | | Concentration | flux |
| | Working media | (% by weight) | (m/h) |
| Example 1 | Seawater (saline water) | 3.5 | 0.015 |
| Example 2 | Sodium gluconate aqueous | Saturated | 0.045 |
| | solution | | |
| Example 3 | Sodium glucuronate aqueous | Saturated | 0.043 |
| | solution | | |
| Example 4 | Sodium ascorbate aqueous | Saturated | 0.047 |
| | solution | | |
| Example 5 | Imidazolium acetate aqueous | 70 | 0.012 |
| | solution | | |

As is clear from Table 1 above, the working media of Examples 2 to 4 which are used aqueous solutions containing carboxylates having two or more hydroxy groups in a side chain, that is, sodium gluconate, sodium glucuronate and sodium ascorbate, respectively, each exhibited a permeation flux of about 3 times higher than that of seawater of Example 1. By contrast, the working medium of Example 5 which used an aqueous solution which contains an organic acid salt which does not contain two or more hydroxy groups in a side chain (an imidazolium acetate aqueous solution) exhibited a permeation flux inferior to that of seawater.

### EXAMPLES 6 to 18

As in Example 1, the respective working medium indicated in Table 2 below was accommodated in the first syringe 211, and freshwater was accommodated in the second syringe 212 (see (c) of FIG. 4).

TABLE 2

| | | mixture ratio |
|---|---|---|
| | Working media | (by weight) |
| Example 6 | Saturated aqueous solution of glycerol (A) | — |
| Example 7 | Saturated aqueous solution of xylitol (B) | — |
| Example 8 | Saturated aqueous solution of sodium | — |
| | gluconate (C) | |
| Example 9 | Saturated aqueous solution of sodium | — |
| | glucuronate (D) | |
| Example 10 | Saturated aqueous solution of sodium | — |
| | ascorbate (E) | |
| Example 11 | Mixture of aqueous solutions C + D | C:D = 1:1 |
| Example 12 | Mixture of aqueous solutions C + E | C:E = 1:1 |
| Example 13 | Mixture of aqueous solutions D + E | D:E = 1:1 |
| Example 14 | Mixture of aqueous solutions B + C | B:C = 1:1 |
| Example 15 | Mixture of aqueous solutions B + E | B:E = 1:1 |
| Example 16 | Mixture of aqueous solutions A + B | A:B = 1:1 |
| Example 17 | Mixture of aqueous solutions B + C + D | B:C:D = 1:1:1 |
| Example 18 | Mixture of aqueous solutions C + D + E | C:D:E = 1:1:1 |

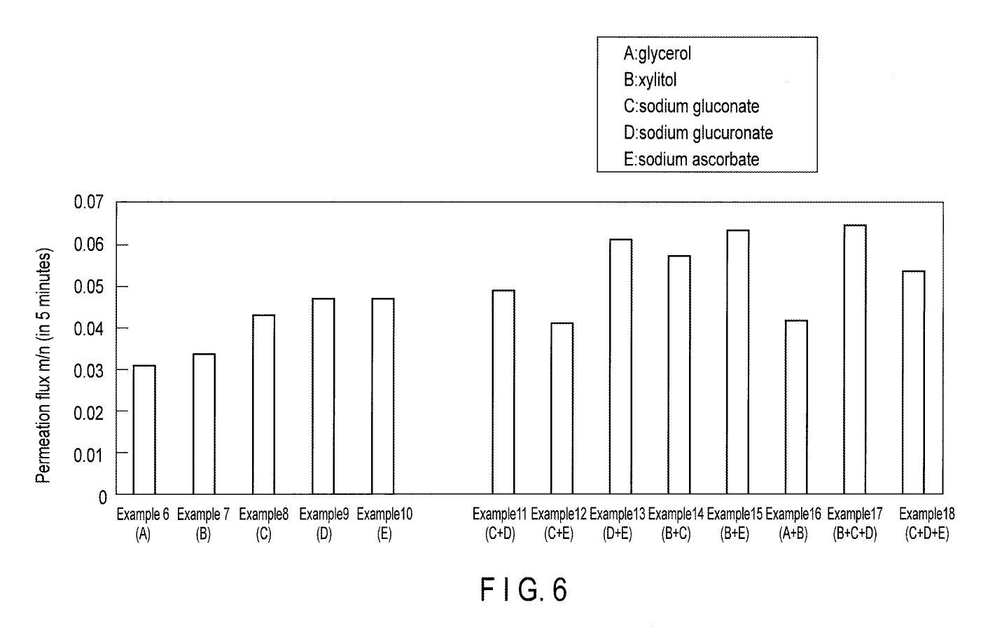

With the state where the respective working medium shown in Table 2 above was accommodated in the first syringe 211 and freshwater was accommodated in the second syringe 212 as shown in FIG. 5, the test device was set vertically still with the first syringe 211 located above and the second syringe 212 located below under the conditions of 25° C. and 1 atmosphere. It was observed that the freshwater introduced into the second syringe 212 downside rose. The height of the freshwater introduced into the second syringe 212 downside rose in 5 minutes was obtained as the permeation flux. The results are shown in FIG. 6.

As is clear from FIG. 6, the working medium of Example 8 containing sodium gluconate (C) solely, that of Example 9 containing sodium glucuronate (D) solely and that of Example 10 containing sodium ascorbate (E) solely, each exhibited a permeation flux higher than that of Example 6 containing glycerol (A) solely or that Example 7 containing xylitol (B) solely.

Further, the working medium of Example 11 containing the mixture of C+D, that of Example 13 containing the mixture of D+E, that of Example 14 containing the mixture of B+C, that of Example 15 containing the mixture of B+E and that of Example 16 containing the mixture of A+B each exhibited a permeation flux higher than that obtained with the working media of Examples 6 to 10, each containing one of these components solely.

Note one exception that the working medium of Example 12 containing the mixture of C+E exhibited a permeation flux lower than that of Example 8 containing C solely or Example 10 containing E solely. However, a higher permeation flux was obtained in Example 12 as compared to the working medium of Example 6 containing glycerol (A) solely or that of Example 7 containing xylitol (B) solely.

Further, a still higher permeation flux was obtained with the working medium of Example 17 containing the mixture of three ingredients of B+C+D and that of Example 18 containing the mixture of three ingredients of C+D+E as compared to that of Example 14 containing the mixture of two ingredients of B+C or that of Example 11 containing the mixture of two ingredients of C+D.

### EXAMPLE 19

As in Example 1, the respective working medium including various kinds, namely, 100%-sodium gluconate, four kinds of mixtures of xylitol and sodium gluconate at different molar ratios and 100%-xylitol, was accommodated in the first syringe 211 and freshwater was accommodated in the second syringe 212 (see in (c) of FIG. 4). With the above-described state, the test device was set vertically still with the first syringe 211 located above and the second syringe 212 located below as shown in FIG. 5 under the conditions of 25° C. and 1 atmosphere. It was observed that the freshwater introduced into the second syringe 212 downside rose. The height of the freshwater introduced into the second syringe 212 downside rose in 5 minutes was obtained as the permeation flux. The results are shown in FIG. 7. In FIG. 7, the horizontal axis indicates the molar ratio between xylitol and sodium gluconate, with 0 at the left end indicating 100%-sodium gluconate, and 1 at the right end indicating 100%-xylitol. A vertical axis on the left-hand side indicates the permeation rate m/h (in 5 minutes), and another vertical axis on the right-hand side indicates the total number of moles of xylitol and sodium gluconate.

Xylitol has a molecular weight of 152.15 g/mol and sodium gluconate has a molecular weight of 218.14 g/mol. Xylitol has a molecular weight less than that of sodium gluconate, but it does not electrolytically dissociate (ionize), and therefore the total molar concentration decreases as the molar fraction of xylitol increases. This is clear from square-shaped points plotted in FIG. 7 which shows the relationship between the molar ratio and the total number of moles of xylitol and sodium gluconate. If the permeation flux is dependent only on molar concentration, an additivity is established between the molar ratio of xylitol and sodium gluconate and the permeation flux as indicated by the straight line shown in FIG. 7. However, in the relationship between the molar ratio of xylitol and sodium gluconate and the permeation flux, shown in FIG. 7, some molar ratio values which deviated from the straight line (additivity line) appeared, as plotted in a diamond shape. That is, if xylitol increases, the permeation flux should decrease according to the additivity line, but conversely, molar ratios at which the permeation flux increases appear. At the molar ratio of xylitol being 0.42 (xylitol:sodium gluconate=1:1 by weight ratio), the permeation flux increased significantly. This was an unexpected effect (result) among the cases of working media containing mixtures of two kinds, xylitol and sodium gluconate.

In addition, it was further an unexpected effect (result) that the permeation flux increased significantly also in the working medium of Example 11 described above (containing the mixture of sodium gluconate+sodium glucuronate [weight ratio of 1:1]), that of Example 13 (containing the mixture of sodium glucuronate+sodium ascorbate [weight ratio of 1:1]), that of Example 15 (containing the mixture of xylitol+sodium ascorbate [weight ratio of 1:1]), that Example 16 (containing the mixture of glycerol+xylitol [weight ratio of 1:1]), that of Example 17 (containing the mixture of xylitol+sodium gluconate+sodium glucuronate [weight ratio of 1:1:1]), and that of Example 18 (containing the mixture of sodium gluconate+sodium glucuronate+sodium ascorbate [weight ratio of 1:1:1]), as shown in FIG. 6.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A water treatment system, comprising:
a first chamber which accommodates water to be treated;
a second chamber which accommodates a working medium which induces an osmotic pressure; and
an osmosis membrane which separates the first chamber and the second chamber from each other,
wherein the working medium is an aqueous solution comprising which contains an acid having a hydroxy group in a side chain, or a metal salt thereof.

2. The water treatment system of claim 1, wherein the working medium is an aqueous solution comprising which contains a mixture of at least two compounds selected from the group consisting of an acid having a hydroxy group in a side chain, a metal salt of an acid having a hydroxy group in a side chain and a polyhydric alcohol represented by Formula 1: 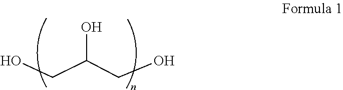
where n is an integer of 0 to 6.

3. The water treatment system of claim 1, wherein the working medium is an aqueous solution comprising a carboxylic acid having a hydroxy group in a side chain, or an equivalent thereof.

4. The water treatment system of claim 3, wherein the carboxylic acid having a hydroxy group in a side chain has a structure of hydroxycarboxylic acid represented by Formula 2: 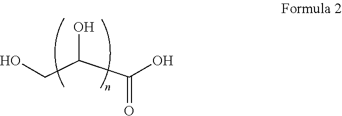
where n is an integer of 0 to 6.

5. The water treatment system of claim 3, wherein the carboxylic acid having a hydroxy group in a side chain has a structure of uronic acid derived from a monosaccharide represented by Formula 3:

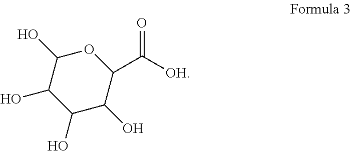 [SMILES: O=C(O)C1OC(O)C(O)C(O)C1O]

6. The water treatment system of claim 5, wherein the uronic acid derived from a monosaccharide is changed to a hydrolyzed structure which is represented by Formula 4 or a lactonized structure represented by Formula 5, to be contained in the working medium:

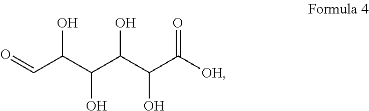 [SMILES: O=CC(O)C(O)C(O)C(O)C(=O)O]

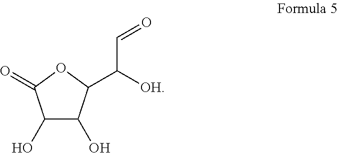 [SMILES: O=CC(O)C1OC(=O)C(O)C1O]

7. The water treatment system of claim 3, wherein the working medium is an aqueous solution comprising an equivalent of the carboxylic acid having a hydroxy group in a side chain is represented by Formula 6: 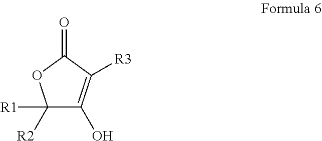
where R1, R2 and R3 each indicates a substituent selected from hydrogen, OH group and a polyol chain, and may be the same or different.

8. The water treatment system of claim 1, wherein the working medium is an aqueous solution comprising an alkali metal salt of a carboxylic acid represented by Formula 2, Formula 8 or Formula 6: 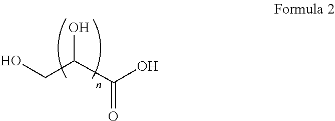
where n is an integer of 0 to 6, 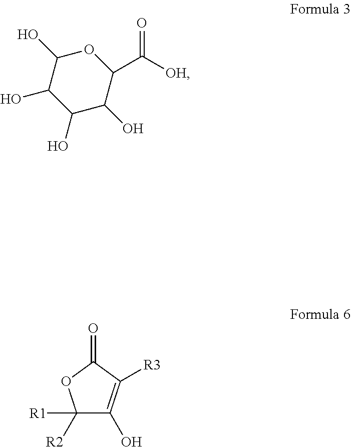
where R1, R2 and R3 each indicates a substituent selected from hydrogen, OH group and a polyol chain, and may be the same or different.

9. A water treatment system, comprising:
a first chamber which accommodates water to be treated;
a second chamber which accommodates a working medium which induces an osmotic pressure;
an osmosis membrane which separates the first chamber and the second chamber from each other;
a pressure exchanger connected to the second chamber; and
a rotator connected to the pressure exchanger,
wherein the working medium is an aqueous solution comprising an acid having a hydroxy group in a side chain, or a metal salt thereof.

10. The water treatment system of claim 9, wherein the working medium is an aqueous solution comprising a mixture of at least two compounds selected from the group consisting of an acid having a hydroxy group in a side chain, a metal salt of an acid having a hydroxy group in a side chain and a polyhydric alcohol represented by Formula 7:

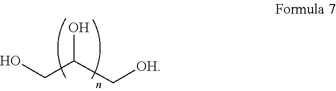

11. A working medium for a water treatment system, which induces an osmotic pressure and is an aqueous solution comprising an acid having a hydroxy group in a side chain, or a metal salt.

12. The working medium of claim 11, wherein the working medium is an aqueous solution comprising a mixture of at least two compounds selected from the group consisting of an acid having a hydroxy group in a side chain, a metal salt of an acid having a hydroxyl group in a side chain and a polyhydric alcohol represented by Formula 8: 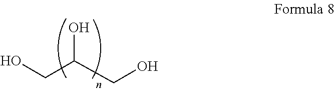
where n is an integer of 0 to 6.

13. The working medium of claim 11, wherein the aqueous solution comprises a carboxylic acid having a hydroxy group in a side chain, or an equivalent thereof.

14. The working medium of claim 13, wherein the carboxylic acid having a hydroxy group in a side chain has a structure of hydroxycarboxylic acid represented by Formula 9: 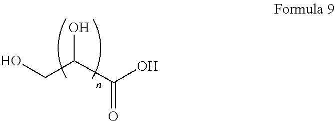
where n is an integer of 0 to 6.

15. The working medium of claim 13, wherein the carboxylic acid having a hydroxy group in a side chain has a structure of uronic acid derived from a monosaccharide represented by Formula 10:

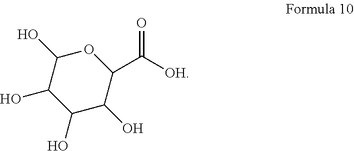 [SMILES: O=C(O)C1OC(O)C(O)C(O)C1O]

16. The working medium of claim 15, wherein the uronic acid derived from a monosaccharide is changed to a hydrolyzed structure which is represented by Formula 11 or a lactonized structure represented by Formula 12:

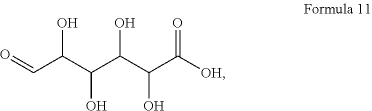 [SMILES: O=CC(O)C(O)C(O)C(O)C(=O)O]

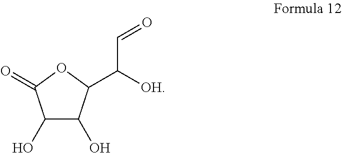 [SMILES: O=CC(O)C1OC(=O)C(O)C1O]

17. The working medium of claim 13, wherein the aqueous solution comprises carboxylic acid having a hydroxy group in a side chain is represented by Formula 13: 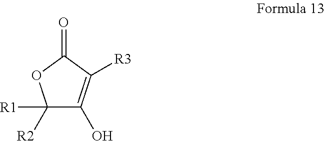
where R1, R2 and R3 each indicates a substituent selected from hydrogen, OH group and a polyol chain, and may be the same or different.

18. The working medium of claim 11, which is an aqueous solution comprising an alkali metal salt of a carboxylic acid represented by Formula 9, Formula 10 or Formula 13: 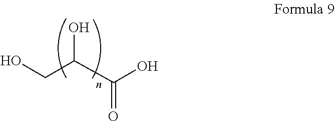
where n is an integer of 0 to 6, 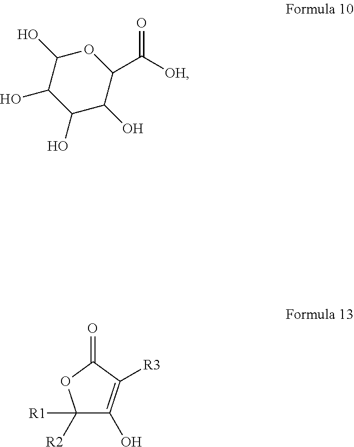
where R1, R2 and R3 each indicates a substituent selected from hydrogen, OH group and a polyol chain, and may be the same or different.
